(19) United States
(12) Patent Application Publication
(10) Pub. No.: US 2017/0293355 A1
(43) Pub. Date: Oct. 12, 2017

(54) METHOD AND APPARATUS FOR ASSIGNING CONTROL INSTRUCTIONS IN A VEHICLE, AND VEHICLE

(71) Applicant: Robert Bosch GmbH, Stuttgart (DE)

(72) Inventor: Benoit Mangin, Stuttgart (DE)

(21) Appl. No.: 15/479,358

(22) Filed: Apr. 5, 2017

(30) Foreign Application Priority Data
Apr. 7, 2016 (DE) 102016205797.9

(51) Int. Cl. G06F 3/01; B60W 50/10; B60R 11/04; B60W 40/08; G06F 3/0362; B60K 37/06

(52) U.S. Cl. CPC G06F 3/013; G06F 3/012; G06F 3/0362; B60K 37/06; B60R 11/04; B60W 40/08; B60W 50/10; G06F 3/0304

(57) ABSTRACT

A method for assigning control instructions in a vehicle includes reading in an occupant gaze datum via an interface to an occupant detection device of the vehicle, the occupant gaze datum representing a gaze of an occupant of the vehicle toward a device of the vehicle which is to be controlled; and assigning a control instruction of a first control device of the vehicle and/or a control instruction of a second control device of the vehicle to the device using the occupant gaze datum, in order to control the device with the first control device or the second control device.

### CROSS-REFERENCE TO RELATED APPLICATIONS

The present application claims priority under 35 U.S.C. §119 to DE 10 2016 205 797.9, filed in the Federal Republic of Germany on Apr. 7, 2016, the content of which is incorporated by reference herein in its entirety.

### FIELD OF THE INVENTION

The present invention relates to a system and method by which a vehicle occupant can control any of multiple devices to be controlled, depending on a detected gaze direction of the vehicle occupant, using any of multiple controlling devices depending which of the controlling devices is being manipulated by the occupant at a time corresponding to when the occupant's gaze is assigned to one of the multiple devices to be controlled.

### BACKGROUND

In modern vehicles, the number of functions that an occupant of the vehicle can manually control and configure according to the occupant's own desires and needs is continually increasing.

### SUMMARY

In light of the above, example embodiments of the present invention are directed to a method for assigning control instructions in a vehicle, an apparatus that uses the method, a vehicle, and a corresponding computer program.

Control instructions of at least a first and/or a second control device of the vehicle can be assigned to the device that is to be controlled using an occupant gaze datum that represents a gaze of an occupant of the vehicle toward a device of the vehicle which is to be controlled.

One and the same control device can be used to control different systems in the vehicle. For example, a scroll wheel integrated into a steering wheel of the vehicle and/or a rotary knob in a central console of the vehicle can be used to control either a combination instrument or a central operating and indicating element in the vehicle. This allows a vehicle occupant, for example the driver, greater flexibility in interacting with the vehicle. If the occupant has the occupant's hands on the wheel, for example, the occupant can use the scroll wheel without needing to reach for the rotary knob. Conversely, if the occupant's right arm is resting on an armrest, it is possibly more convenient for the occupant to reach for the rotary knob for operation.

According to an example embodiment, a method for assigning control instructions in a vehicle includes: reading in an occupant gaze datum via an interface to an occupant detection device of the vehicle, the occupant gaze datum representing a gaze of an occupant of the vehicle toward a device of the vehicle which is to be controlled; and assigning a control instruction of a first control device of the vehicle and/or a control instruction of a second control device of the vehicle to the device using the occupant gaze datum, in order to control the device with the first control device or the second control device.

The occupant detection device can be located in an interior of the vehicle and can have a camera that is directed toward a head of the occupant. The occupant can be a driver of the vehicle. The occupant gaze datum can be constructed based on data of a detection of the eyes and head of the occupant by the camera. The device to be controlled can be assigned, for example, to a combination instrument, to a driver assistance system, or to an infotainment system of the vehicle. The “control devices” can be understood as manually actuatable electrical operating means of the vehicle such as switches, buttons, knobs, etc. The control instructions can exist in the form of electrical signals and can be generated by a manual actuation of the control devices by the occupant.

This method can be implemented, for example, in a control device, for example in software or hardware or in a mixed form of software and hardware.

According to an example embodiment, the method includes generating the occupant gaze datum using a gaze direction datum and/or a head posture datum of an optical sensor of the occupant detection device. The gaze direction datum can represent coordinates of a current gaze direction of the occupant, and the head posture datum can represent coordinates of a current head posture of the occupant. The optical sensor can be assigned to a camera for occupant monitoring or driver monitoring as part of the occupant detection device. The occupant gaze datum can thereby be generated without difficulty using generally available data of a conventional driver monitoring camera.

For example, in the assigning step, a control instruction of the first control device can be generated by a manual actuation of the first control device, and/or a control instruction of the second control device can be generated by a manual actuation of the second control device. This embodiment of the method allows the occupant to execute a simple, rapid, and intuitive control intervention with regard to the device or the further device of the vehicle.

According to an example embodiment, the method includes outputting, in response to the assigning step, an indicating signal to the device to be controlled. The indicating signal can be configured to visually, optically, and/or acoustically indicate to the occupant the device that is to be controlled. An acknowledgment regarding a device currently being controlled can thereby readily be given to the occupant.

According to a further example embodiment, in the assigning step, a control instruction of a scroll wheel integrated into a steering wheel of the vehicle, constituting the first control device of the vehicle, can be assigned to the device, and/or a control instruction of a rotary knob integrated into a center console of the vehicle, constituting the second control device of the vehicle, can be assigned to the device. According to this embodiment, the occupant can advantageously configure the operation of the device or of the further device, as a function of a current hand position or arm position, conveniently and in a manner that improves driving safety.

The method can furthermore have a step of furnishing a second occupant gaze datum via the interface to the occupant detection device of the vehicle. The second occupant gaze datum can represent a gaze by the occupant toward a further device of the vehicle which is to be controlled. In the assigning step, a control instruction of the first control device and/or a control instruction of the second control device can correspondingly be assigned to the further device, using the second occupant gaze datum, in order to control the further device with the first control device or with the second control device. The second occupant gaze datum can be generated or furnished at a second point in time that can be later in time than the first point in time. According to this embodiment, devices disposed at different positions in the vehicle can be controlled using different gaze direction data and head posture data of the occupant.

According to a further example embodiment, in the assigning step, a control instruction of the first control device and/or a control instruction of the second control device can be assigned to a first one of a group of a combination instrument and a central operating and indicating element of the vehicle, constituting the device, and/or, in the further assigning step, a control instruction of the first control device and/or a control instruction of the second control device can be assigned to a second one of the group of the combination instrument and the central operating and indicating element of the vehicle, constituting the further device. Two centrally important devices of the vehicle can thus be operated simply, quickly, and reliably by way of controlling gazes and hand motions of the occupant.

The approach presented here furthermore creates an apparatus that is configured to carry out, activate, or implement the steps of a variant of the method presented here in corresponding devices. The object on which the invention is based can also be quickly and efficiently achieved by way of this variant embodiment of the invention in the form of an apparatus.

For this, the apparatus can have at least one computation unit for processing signals or data, at least one memory unit for storing signals or data, at least one interface to a sensor or to an actuator for reading in sensor signals from the sensor or for outputting data signals or control signals to the actuator, and/or at least one communication interface for reading in or outputting data that are embedded in a communication protocol. The computation unit can be, for example, a signal processor, a microcontroller, or the like, and the memory unit can be, for example, a flash memory, an EPROM, or a magnetic memory unit. The communication interface can be configured to read in or to output data wirelessly and/or in wire-based fashion, for example, the latter being able to read in those data from a corresponding data transfer line or output them into a corresponding data transfer line, for example, electrically or optically.

An “apparatus” can be understood in the present case, for example, as an electrical device that processes sensor signals and outputs control signals and/or data signals as a function thereof. The apparatus can have an interface that can be configured in hardware-based and/or software-based fashion. With a hardware-based configuration, the interface can be, for example, part of a so-called “system ASIC” that contains a wide variety of functions of the apparatus. It is also possible, however, for the interfaces to be dedicated integrated circuits or to be made up at least partly of discrete components. With a software-based configuration, the interfaces can be software modules that are present, for example, on a microcontroller alongside other software modules.

In an advantageous example embodiment, selective control of a combination instrument and of an infotainment system of a vehicle is accomplished by way of the apparatus. The apparatus can access for this purpose, for example, electrical signals such as a control instruction of a first or second control device or of a first or second actuator of the vehicle. Control application is effected via actuators such as a scroll wheel, a rotary knob, a toggle switch, a button, or a directional pad.

The apparatus can furthermore have a control switch. The control switch can be configured to assign a control instruction of a first control device of the vehicle to a device to be controlled, and/or to assign a control instruction of a second control device of the vehicle to the device to be controlled, using an occupant gaze datum. Assignment of the control instructions can thereby be configured quickly and robustly.

An example embodiment is directed to a vehicle including an occupant detection device and an apparatus, coupled to the occupant detection device, according to one of the example embodiments explained above.

An example embodiment is directed to a computer program product or computer program having program code stored on a machine-readable medium or storage medium such as a semiconductor memory, a hard drive memory, or an optical memory and being used to carry out, implement, and/or activate the steps of the method according to one of the example embodiments described above, in particular when the program product or program is executed on a computer or an apparatus.

Exemplifying embodiments of the approach presented here are depicted in the drawings and explained in further detail in the following description of example embodiments of the present invention, in which drawings and description identical or similar reference characters are used for similarly functioning elements that are depicted in the various figures, without repetition of the description of those elements for the different figures.

### BRIEF DESCRIPTION OF THE DRAWINGS

FIG. 1 schematically depicts a vehicle having an occupant detection device, according to an example embodiment of the present invention.

FIG. 2 shows a switching logic of a system for assigning control instructions in a vehicle, according to an example embodiment of the present invention.

FIG. 3 is a flowchart of a method for assigning control instructions in a vehicle, according to an example embodiment of the present invention.

FIG. 4 depicts a vehicle interior having devices controllable with the use of an apparatus for assigning control instructions, according to an example embodiment of the present invention.

FIG. 5 depicts an example of a control device, according to an example embodiment of the present invention.

### DETAILED DESCRIPTION

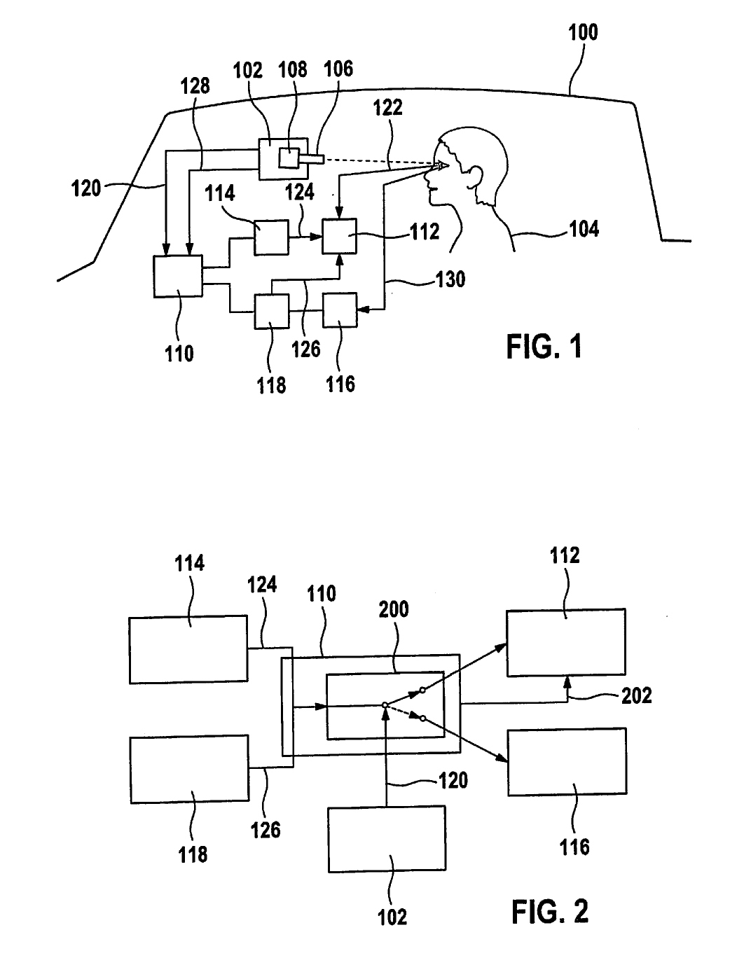

FIG. 1 schematically depicts a vehicle 100. Vehicle 100 is a road-going vehicle, in this case a passenger car. Vehicle 100 can also be a truck or other commercial vehicle. Vehicle 100 has an occupant detection device 102 for detection of an occupant 104 (here a driver) of vehicle 100. An optical sensor 106 of a camera 108 of occupant detection device 102 is directed toward a head of occupant 104 in order to monitor occupant 104. Driver monitoring camera 108 is configured to detect a gaze direction and/or a head posture (i.e., a position and angle of the head) of occupant 104, for example, continuously while vehicle 100 is being driven. In the context of an original function of occupant detection device 102, the detected data are processed in a computation unit of occupant detection device 102 in order to establish the direction in which driver 104 is gazing and whether his or her attention is directed toward the road or is diverted. Driver monitoring camera 108 is positioned, for example, directly in front of driver 104, for example in the combination instrument or in the steering column of vehicle 100.

Driver detection device or occupant detection device 102 shown by way of example in FIG. 1 is often already available as standard equipment in high-end passenger cars, and is also suitable for use, for example, in buses.

In an example embodiment of the present invention, an apparatus 110 for assigning control instructions is provided in vehicle 100. Apparatus 110 is electrically conductively connected to occupant detection device 102. Apparatus 110 is furthermore electrically conductively connected, for example via a CAN bus of vehicle 100, (a) to a device 112 and a first control device 114, the latter of which is assigned in a default setting to the device 112, and (b) to a further device 116 and a second control device 118, the latter of which is assigned in the default setting to the further device 116.

Depending on the exemplifying embodiment, apparatus 110 can be accommodated in a shared housing with occupant detection device 102, or can be disposed physically remotely from occupant detection device 102 in vehicle 100 and coupled to occupant detection device 102, for example, via the CAN bus of vehicle 100.

In the scenario shown in FIG. 1, at a first point in time occupant 104 is gazing toward device 112 of vehicle 100 with the intention of controlling device 112 or modifying or at least checking a current setting of device 112. Device 112 is, for example, a combination instrument or a part of a combination instrument of vehicle 100. Camera 108 constantly detects eye and head movements of occupant 104 by way of optical sensor 106, and correspondingly supplies gaze and head posture data to a computation unit of occupant detection device 102.

Occupant detection device 102 is configured to generate an occupant gaze datum 120 using a gaze direction datum and/or head posture datum based on the gaze data or head posture data of camera 108, and to furnish it via a suitable interface to apparatus 110. The gaze direction datum or head posture datum represents, for example, coordinates of a current gaze direction or a current head posture of occupant 104. Occupant gaze datum 120 represents a gaze 122 of occupant 104 toward device 112 of vehicle 100 which is to be controlled.

According to an alternative exemplifying embodiment, apparatus 110 is configured to read in the gaze direction datum and/or head posture datum from occupant detection device 102 and to generate occupant gaze datum 120.

Apparatus 110 is furthermore configured to assign to device 112, using occupant gaze datum 120 and in response to a manual actuation of first control device 114 or of second control device 118 by occupant 104, a control instruction 124 of first control device 114 or a control instruction 126 of second control device 118. In the scenario sketched in FIG. 1, this means that in the case of a manual actuation of first control device 114, an assignment existing in the default setting is maintained, and first control instruction 124 generated by manual actuation of first control device 114 is furnished in standard fashion to device 112. In the case of a manual actuation of second control device 118 by occupant 104, however, apparatus 110 causes a redirection of second control instruction 126 generated by manual actuation of second control device 118. That instruction is then no longer furnished to further device 116 as in the default setting, but instead is furnished likewise to device 112.

In accordance with the concept sketched here, apparatus 110 therefore allows occupant 104 to apply control, both via first control device 114 and via second control device 118, to device 112 that occupant 104 is aiming to control, depending on what is more convenient or safer for occupant 104 in a current situation.

Apparatus 110 analogously assigns a control instruction of first control device 114 and/or a control instruction of second control device 118 to further device 116, using a second occupant gaze datum 128 that represents a gaze 130 of occupant 104 toward further device 116, in order to control further device 116 with first control device 114 or with second control device 118. Occupant 104 directs gaze 130, for example, at an interval in time with respect to gaze 122.

The concept of assigning multiple functions to a single control device, as presented on the basis of the scenario shown in FIG. 1, can be expanded to any number of control devices and to any number of devices in vehicle 100.

FIG. 2 shows a switching logic to explain the system illustrated in FIG. 1 for assigning control instructions in a vehicle, according to an exemplifying embodiment. As already explained in connection with FIG. 1, apparatus 110 is electrically conductively connected on the one hand to occupant detection device 102 and on the other hand both to first control device 114 and to second control device 118, and to device 112 and to further device 116.

In the exemplifying embodiment shown in FIG. 2, first control device 114 is represented by a scroll wheel 114, second control device 118 by a rotary knob 118, device 112 by a combination instrument 112, and further device 116 by a central operating and indicating element 116. Scroll wheel 114 is integrated, for example, into a steering wheel of a vehicle and is typically configured to control devices of combination instruction 112. According to an exemplifying embodiment, rotary knob 118 is located on a center console in the vehicle and is typically provided for controlling devices of an infotainment system of the vehicle. Control is usually applied to the infotainment system via central operating and indicating element 116, which is often disposed above the center console in the form of a display screen.

Apparatus 110 encompasses a control switch 200 that performs a redirection, suitable in accordance with the approach presented here, of the instructions furnished by control devices 114, 118. Control switch 200 is an electrical operating means for converting a manual actuation into a signal intended for further processing.

Control switch 200 redirects control instructions furnished by control devices 114, 118 depending on whether occupant gaze datum 120 most recently furnished by occupant detection device 102 to apparatus 110 prior to an actuation of first control device 114 or of second control device 118 represents an occupant's gaze toward combination instrument 112 or toward central operating and indicating element 116. In the switching logic shown in FIG. 2, for example, occupant gaze datum 120 represents the occupant's gaze toward combination instrument 112 as the most recent gaze prior to a manual actuation of one of control elements 114, 118 by the occupant. In accordance with a first switching position shown in FIG. 2, control switch 200 redirects one or more control instructions 124 of scroll wheel 114 and one or more control instructions 126 of rotary knob 118 to combination instrument 112.

According to an exemplifying embodiment, in response to the assignment of control instructions 124, 126, apparatus 110 furnishes an indicating signal 202 to the device that is currently to be controlled (in this case, combination instrument 112). Indicating signal 202 generates a visual and/or optical and/or acoustic feedback that assignment has occurred, indicating to the occupant which of the devices 112, 116 shown by way of example in FIG. 2 the occupant is currently controlling. For example, visual feedback in the form of a light-emitting display in or around a display screen of combination instrument 112 is advantageous.

If, alternatively, occupant gaze datum 120 or a further occupant gaze datum at a later point in time represents an occupant's gaze toward central operating and indicating element 116 as the most recent gaze prior to a manual actuation of one of control elements 114, 118 by the occupant, control switch 200 switches out of the first switching position into a second switching position characterized by dashed lines in the depiction of FIG. 2, and redirects one or more control instructions 124 of scroll wheel 114, and one or more control instructions 126 of rotary knob 118, to display screen 116 of the infotainment system.

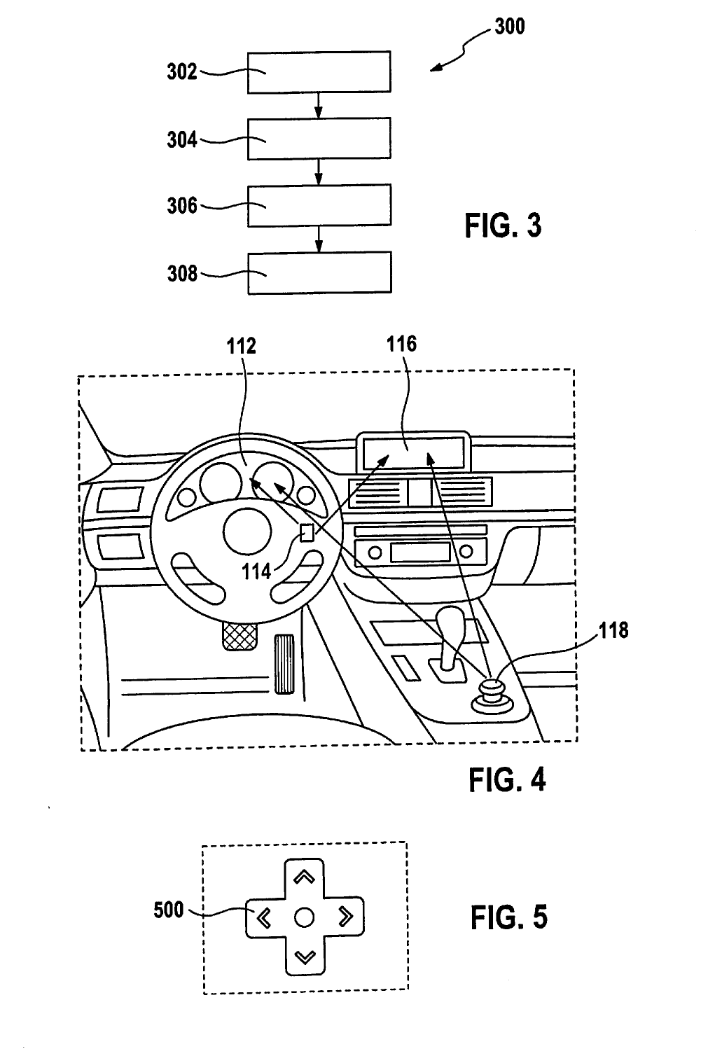

FIG. 3 is a flowchart of an exemplifying embodiment of a method 300 for assigning control instructions in a vehicle. Method 300 can be executed by the apparatus shown in FIGS. 1 and 2 for assigning control instructions in a vehicle.

In a reading-in step 302, an occupant gaze datum that represents a vehicle occupant's gaze toward a device of the vehicle which is to be controlled is read in via an interface to an occupant detection device of the vehicle.

In an assigning step 304, a control instruction of a first control device of the vehicle and/or a control instruction of a second control device of the vehicle is assigned to the device using the occupant gaze datum, in order to control the device with the first control device or the second control device.

In a furnishing step 306 that is executed at a later point in time than the reading-in step 302, a second occupant gaze datum is furnished via the interface to the occupant detection device of the vehicle. The second occupant gaze datum represents the occupant's gaze toward a further device of the vehicle which is to be controlled.

In a further assigning step 308, a control instruction of the first control device and/or a control instruction of the second control device is assigned to the further device using the second occupant gaze datum, in order to control the further device with the first control device or the second control device.

FIG. 4 depicts an example of a vehicle interior of a passenger car. The vehicle interior is shown from the perspective of an occupant in the driver's seat of the passenger car. An exemplifying scroll wheel 114 is integrated into the steering wheel of the passenger car. As its conventional function, scroll wheel 114 is typically used to control the menu of combination instrument 112 of the passenger car. The occupant can operate scroll wheel 114 while the occupant's hands are on the steering wheel. For example, the occupant can operate scroll wheel 114 with a finger by rotating it upward or downward. A rotation of scroll wheel 114 generates a control instruction for controlling a display screen of combination instrument 112.

In a conventional configuration the display screen, or operating and indicating element 116, of an infotainment system of the passenger car is controlled using a touch display or using rotary knob 118 that is integrated into the center console in the passenger car. The occupant can turn rotary knob 118 to the right or left in order to operate operating and indicating element 116. A rotation of rotary knob 118 generates a control instruction for controlling operating and indicating element 116. Because operating and indicating element 116 is typically disposed above the center console, it is also referred to as “head unit” 116.

In accordance with the concept presented here, of assigning multiple functions to one operating element 114, 118, the occupant can operate device 112, 116 with scroll wheel 114 or with rotary knob 118, based on the device 112, 116 toward which the occupant is gazing.

For example, if the occupant has the occupant's hands on the steering wheel and wishes to operate operating and indicating element 116, the occupant no longer needs to remove the occupant's hands from the wheel in order to grasp rotary knob 118. The occupant can instead use scroll wheel 114 in the steering wheel. Conversely, if the occupant's right arm is resting on the armrest behind the center console, it is possibly more convenient for the occupant to reach for rotary knob 118.

Based on gaze direction recognition using a driver monitoring device directed toward the occupant's head, the occupant can use scroll wheel 114, and alternatively rotary knob 118, to control both devices 112, 116, as illustrated graphically in the depiction of FIG. 4 by directional arrows proceeding from control devices 114, 118.

The novel concept proposed here can be transferred to as many devices, or display screens thereof, as are present in the passenger car. The proposed concept can of course also be applied to elements that do not have display screens. For example, based on a detected gaze toward the climate control region in the passenger car the temperature in the passenger car can be regulated upward or downward, for example, by turning scroll wheel 114 or rotary knob 118.

According to a further exemplifying embodiment, based on a detected gaze toward the mirrors in the vehicle, individual settings of all the mirrors in the vehicle can be configured using a directional pad 500 as the control device that is to be utilized, as shown by way of example in FIG. 5.

The concept presented herein can be applied to all types of operating elements or input devices such as knobs, joysticks, pushbuttons, switches, or even elements such as voice control or gesture recognition.

It is furthermore conceivable for the control devices to be “non-displays,” for example the control units of the climate control system in the vehicle, or the outside mirrors. A display can also be subdivided into areas, and each area can be operated individually depending on which of the areas the vehicle occupant is gazing toward. Another aspect of the approach presented here is that an acknowledgment of the control unit selected is given to the user or the vehicle occupant. The intention is for the occupant to know which display, which area, or which control unit the occupant is currently operating. For this, the background on the display or on the selected control unit can appear in a different color than the non-selected control units or vehicle elements or can be given a border, or a special feature can be displayed in such a case. Acknowledgment of the selection of a “non-display” element as a control element can occur, for example, via a light source such as an LED. A further aspect of the approach presented here, specifically in the motor vehicle context, can be that when the vehicle occupant looks back at the road, the display, area, non-display unit, or control unit in general that was most recently gazed toward remains active, so that the occupant can continue to operate it without constantly needing to stare at the display. The vehicle occupant is thus less distracted and can, as accustomed, merely verify with monitoring glances that the desired menu is still selected.

If an exemplifying embodiment encompasses an “and/or” relationship between a first feature and a second feature, this is to be read to mean that the exemplifying embodiment according to one embodiment has both the first feature and the second feature, and according to a further embodiment has either only the first feature or only the second feature.

What is claimed is:

1. A method for assigning control instructions in a vehicle, the method comprising:
obtaining, by processing circuitry and via an interface to an occupant detection device of the vehicle, an occupant gaze datum that represents a gaze of an occupant of the vehicle toward a vehicle device that is to be controlled; and
based on the occupant gaze datum, assigning, by the processing circuitry, at least one of a control instruction of a first control device of the vehicle and a control instruction of a second control device of the vehicle to the vehicle device in order to control the vehicle device.

2. The method of claim 1, wherein the obtaining includes generating the occupant gaze datum using at least one of:
a gaze direction datum of the occupant detection device that represents coordinates of a current gaze direction of the occupant; and
a head posture datum of an optical sensor of the occupant detection device that represents coordinates of a current head posture of the occupant.

3. The method of claim 1, wherein at least one of the control instruction of the first control device is generated by a manual actuation of the first control device, and the control instruction of the second control device is generated by a manual actuation of the second control device.

4. The method of claim 1, further comprising:
outputting, to the vehicle device to be controlled and in response to the assigning step, an indicating signal that at least one of visually, optically, and acoustically indicates to the occupant the vehicle device that is to be controlled.

5. The method of claim 1, wherein the first control device is a scroll wheel integrated into a steering wheel of the vehicle and the second control device is a rotary knob integrated into a center console of the vehicle.

6. The method of claim 1, further comprising:
obtaining, via the interface, a second occupant gaze datum that represents a gaze by the occupant toward a further vehicle device that is to be controlled; and
based on the second occupant gaze datum, assigning at least one of a control instruction of the first control device and a control instruction of the second control device to the further vehicle device in order to control the further vehicle device.

7. The method of claim 6, wherein one of the vehicle device and further vehicle device is a combination instrument and the other of the vehicle device and further vehicle device is a central operating and indicating element of the vehicle.

8. A vehicle device arrangement for assigning control instructions in a vehicle, the vehicle device arrangement comprising:
processing circuitry; and
an interface to an occupant detection device of the vehicle;
wherein the processing circuitry is configured to:
obtain via the interface an occupant gaze datum that represents a gaze of an occupant of the vehicle toward a vehicle device that is to be controlled; and
based on the occupant gaze datum, assign at least one of a control instruction of a first control device of the vehicle and a control instruction of a second control device of the vehicle to the vehicle device in order to control the vehicle device.

9. The vehicle device arrangement of claim 8, wherein the processing circuitry includes a control switch that is configured to perform the assignment.

10. The vehicle device arrangement of claim 8, further comprising the occupant detection device.

11. A non-transitory computer-readable medium on which are stored instructions that are executable by a processor and that, when executed by the processor, cause the processor to perform a method for assigning control instructions in a vehicle, the method comprising:
obtaining, via an interface to an occupant detection device of the vehicle, an occupant gaze datum that represents a gaze of an occupant of the vehicle toward a vehicle device that is to be controlled; and
based on the occupant gaze datum, assigning at least one of a control instruction of a first control device of the vehicle and a control instruction of a second control device of the vehicle to the vehicle device in order to control the vehicle device.
